(19) United States
(12) Patent Application Publication
(10) Pub. No.: US 2006/0150860 A1
(43) Pub. Date: Jul. 13, 2006

(54) Alkali-resistant cocoon-shaped colloidal silica particle and process for producing the same

(76) Inventor: Toshio Nozaki, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/531,589

(22) PCT Filed: Jan. 30, 2004
(86) PCT No.: PCT/JP04/00922

§ 371 Date: Nov. 14, 2005

(30) Foreign Application Priority Data
Feb. 18, 2003 (JP) 2003-039142

(51) Int. Cl. C09G 1/02; C01B 33/12

(52) U.S. Cl. 106/3; 423/335; 423/339

(57) ABSTRACT

The invention provides a highly alkali resistant colloidal silica while retaining an excellent cocoon-shape and excellent performance as abrasive particles, and a process for the manufacture thereof. It is a cocoon-shaped colloidal silica prepared by hydrolyzing and condensing an alkoxysilane condensate in the presence of an ammonia or ammonium salt catalyst. It is also a cocoon-shaped colloidal silica prepared by adding continuously an alkoxysilane condensate or its solution in an aqueous solvent to an aqueous solution of ammonia or an ammonium salt or to an aqueous solution containing ammonia or an ammonium salt and an aqueous solvent, thereby hydrolyzing the alkoxysilane; and further heating under pressure. The temperature to which the foregoing colloidal silica is heated under pressure is preferably 105 to 374.1 ° C.; and the alkoxysilane condensate preferably has an average degree of condensation of 2 to 8.

### FIELD OF THE INVENTION

The present invention relates to highly alkali resistant cocoon-shaped colloidal silica particles and a process for the manufacture thereof. It further specifically relates to cocoon-shaped colloidal silica particles with improved alkali resistance, which are applicable to polishing abrasive particles as used in polishing semiconductors, typically silicon wafers, polishing electronic materials such as hard disk substrate materials, polishing in a planarization process (commonly called Chemical-Mechanical Planarization, chemical mechanical polishing) for fabricating integrated circuits, and like; and a process for the manufacture thereof.

### BACKGROUND OF THE INVENTION

Roles played by precision polishing have recently come to be taken seriously, along with trends of material miniaturization and high degrees of integration, in the steps for fabricating semi-conductor integrated circuits mounted in computers and consumer electronics, and electronic materials such as hard disks and the like. The polishing steps involve those carried out in multiple steps: initial [stock removal] polish and final polish as in polishing silicon wafers and hard disks, and those calling for a number of polishing steps in fabricating a single integrated circuit device as in planarization steps for integrated circuits. In these steps, particularly the final polish step has in general come to extensively use silica fine particles on the order of several tens of nanometers in diameter as abrasive particles. This is because silica makes it relatively facile to produce fine particulate abrasive particles with a narrow particle size distribution as required in precision polishing.

The silica abrasive particles used in the precision polishing of a variety of electronic materials have been manufactured by: 1) A flame hydrolysis method of silicon tetrachloride and the like as represented by fumed silica; 2) A method of decationizing alkaline metal from silicic acid salt such as water glass or the like; 3) A so-called sol-gel method of hydrolyzing alkoxysilanes. A comparison of precision polishing performance in terms of formed surfaces of these three silica types provides the following observations. The silica prepared by a flame hydrolysis method yields string-like agglomerated particles, sometimes makes scratch during polishing. The colloidal silica prepared by a decationization method tends to make the particle size to be non-uniform, use of which in polishing sometimes results in greater polish roughness. Compared to these two types, the colloidal silica prepared by the sol-gel method is considered to have an optimum configuration for precision polishing because it enables one to generate a cocoon-shaped particle preferred for polishing along with its uniform particle size.

Polishing promoters, either acidic or alkaline, are used in precision polishing of electronic materials. Under acidic conditions, silica is extremely stable thereby sufficiently exerting its polishing capability as abrasive particles. However, use of an alkaline material such as ammonia, amines, potassium hydroxide, or the like as a polishing promoter causes a problem when polishing with silica abrasive particles in the alkaline region because silica is liable to be attacked by alkali, which makes the alkali resistance of the silica an important element among its polishing performance. That is, there the problem under alkali conditions is that the silica gradually dissolves and modifies its shape with a decrease in polishing performance. It is known that among these three silica types, 1) to 3), the alkali resistance of the flame hydrolysis silica is the best, and that of the sol-gel silica the worst. Accordingly, the current practice is to take into consideration such properties whereby abrasive particles and polishing promoter types are selected for each field of application.

With respect to the silica which is used in precision polishing of such electronic materials, Japanese Laid-open Patent Application Publication No. H7-221059 teaches a colloidal silica with a ratio of minor to major axis of 0.3 to 0.8 and a major axis of 7 to 1,000 nm. It discloses a process for manufacturing said colloidal silica with an embodiment in which an aqueous sodium silicate solution is used as a starting material. However, the silica sol prepared by the process has been deficient in that it contains, in addition to silicon, alkaline earth metals such as calcium, magnesium, barium, and the like, and transition metals such as copper, iron, nickel, and the like, along with sodium from the raw material sodium silicate, and that these alkaline earth metals, transition metals, and alkaline metals adhere as impurities to the wafer surfaces during wafer polishing, thereby contaminating the wafer surfaces and, as a result, adversely affecting the semiconductor properties or decreasing electrical properties of the oxide film when it is generated on the wafer surface.

It is described in Japanese Patent No. 3195569 that a cocoon-shaped colloidal silica is produced which has a minor axis of 10 to 200 nm and with a major/minor axis ratio of 1.4-2.2 when methyl silicate or a mixture of methyl silicate and methanol is added continuously over 10 to 40 minutes with stirring into a mixed solvent comprising water, methanol, ammonia, and the like. The resultant cocoon-shaped colloidal silica provides excellent performance in precision polishing of electronic materials and the like, except for a deficiency in alkali resistance. In particular, it is observed that under high pH conditions, the colloidal silica gradually dissolves with time accompanied by a gradual change in shape and a deterioration in polishing performance.

In light of the foregoing state of the art, the present invention is aimed at providing a highly alkali resistant colloidal silica which is cocoon-shaped and still maintains its excellent polishing performance, and a process for the manufacture thereof.

### SUMMARY OF THE INVENTION

As a result of their extensive studies for solving the above problem, the present inventors discovered new, heretofore unknown, type of silica fine particles with improved alkali resistance, while having a particulate shape suitable for polishing and retaining excellent polishing performance, and a process for the manufacture thereof, which has resulted in completion of this invention. That is, the gist of this invention is: a cocoon-shaped colloidal silica which does not dissolve in an aqueous alkaline solution of a pH of 11.5 or less. Specifically, it is a cocoon-shaped colloidal silica prepared by hydrolyzing and condensing an alkoxysilane condensate in the presence of an ammonia or ammonium salt catalyst. The resultant colloidal silica not only exhibits excellent performance as abrasive particles, but also excellent alkali resistance.

Heating the cocoon-shaped colloidal silica under pressure can produce a colloidal silica with improved alkali resistance. That is, it is a cocoon-shaped colloidal silica prepared by further heating under pressure the colloidal silica prepared by hydrolyzing an alkoxysilane condensate in the presence of an ammonia or ammonium salt catalyst.

The temperature to which said colloidal silica is heated under pressure is preferably 105 to 374.1° C. Said alkoxysilane condensate preferably has an average degree of condensation of 2 to 8.

As described above, the present invention provides a highly alkali resistant cocoon-shaped colloidal silica. At the least, the colloidal silica of this invention is a cocoon-shaped colloidal silica which is stable under an alkali condition of a pH of 11.5 or less. The alkali resistance of a conventional cocoon-shaped colloidal silica prepared by hydrolysis of an alkoxysilane has been at a pH of 11 or less. The present invention improves the alkali resistance of the cocoon-shaped colloidal silica up to a pH of 11.5.

The resultant highly alkali resistant cocoon-shaped colloidal silica may suitably be used as polishing abrasive particles.

### DETAILED DESCRIPTION

The highly alkali resistant cocoon-shaped colloidal silica may be manufactured by hydrolyzing and condensing an alkoxysilane condensate in the presence of a catalyst such as ammonia. That is, there is provided a process for the manufacture of a cocoon-shaped colloidal silica, the process comprising adding continuously an alkoxysilane condensate or its solution in an aqueous solvent into an aqueous solution of ammonia or an ammonium salt, or into an aqueous solution containing ammonia or an ammonia and an aqueous solvent, thereby hydrolyzing the alkoxysilane [condensate]. Further, heating the cocoon-shaped colloidal silica under pressure may also produce a highly alkali resistant colloidal silica. That is, a process for the manufacture of a cocoon-shaped colloidal silica, the process comprising adding continuously an alkoxysilane condensate or its solution in an aqueous solvent into an aqueous solution of ammonia or an ammonium salt, or into an aqueous solution containing ammonia or an ammonia and an aqueous solvent, thereby hydrolyzing the alkoxysilane [condensate] and further heating under pressure.

The process for the hydrolysis on an alkoxysilane condensate suitably calls for a method of adding continuously and reacting, with stirring, in 10 to 40 minutes, a mixture of an alkoxysilane condensate and an aqueous solvent such as methanol into a mixed solvent comprising water, an aqueous solvent such as methanol, and the like, and ammonia, or ammonia and an ammonium salt. In this case, it is preferred to carry out the reaction at a reaction temperature of 10 to 40° C., where the ammonium ion content in the solvent is 0.5 to 3% by weight of the total weight of the solvent.

The temperature to which the hydrolysate of the alkoxysilane condensate to be heated under pressure is preferably 105-374.1° C.; and said alkoxysilane condensate preferably has an average degree of condensation of 2 to 8. Heating the colloidal silica under pressure requires raising the temperature to 100° C. or higher. Since the critical temperature of water is 374.1° C., the colloidal silica is preferably heated to a temperature of 105 to 374.1° C.

For the preparation of a highly alkali resistant colloidal silica, the present inventors first studied the alkali resistance of various silica types produced by different manufacturing processes. The silica types studied are the three aforementioned types which are typically used in practice as precision polishing abrasive particles: 1) A flame hydrolysis silica; 2) A colloidal silica by decationizing an alkaline metal from silicate salt; 3) A cocoon-shaped silica prepared by hydrolyzing an alkoxysilane. The pHs at which these silica types are soluble at ambient temperature, although somewhat different depending on the manufacturing conditions, are generally: 1) a pH of 12 or higher for the flame hydrolysis silica; 2) a pH of approximately 11.5 for the colloidal silica obtained by decationizing an alkaline metal from silicate salt; and 3) a pH of approximately 11 for the cocoon-shaped colloidal silica prepared by hydrolysis of an alkoxysilane.

The difference in alkali resistance depending on the manufacturing methods is considered to arise from the structure of the silica's terminal groups. That is, 1) the flame hydrolysis silica is a silica essentially terminated with a siloxane bond (—Si—O—Si—), while the colloidal silica types of 2) and 3) are considered to have some residual silicic acid bonding (—Si—OH), a form of a partially hydrated siloxane bonds, for retention of a colloidal state or due to an incomplete condensation reaction. The difference in alkali resistance between 2) and 3) is presumably due to the difference in the proportion of such silicic acid bonds contained therein.

On the basis of these concepts and by noting to minimize the number of silicic acid bonds as far as possible while maintaining a sufficient amount for retaining a colloidal state thereof, the present inventors have extensively studied the production of a cocoon-shaped colloidal silica with minimal silicic acid bonds. The hydrolysis of an alkoxysilane produces, via a condensed alkoxysilane resulting from partial condensation of the alkoxysilane as given by Equation 1, finally a silica. Addition of an insufficient amount of water fails to completely hydrolyze the alkoxysilane, thereby coming to a stop at an alkoxysilane condensate stage. The number of alkoxysilane [molecules] participated in the condensation, i.e., the degree of condensation, n, can be controlled within a moderate range by adjusting the amount of water to be added.

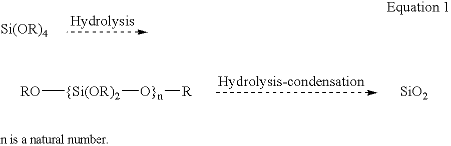

While the conventional process for manufacturing a polishing colloidal silica uses an alkoxysilane itself as a raw material, the present inventors hypothesized that the use of an alkoxysilane condensate obtained by condensation of an alkoxysilane, instead of an alkoxysilane itself as a raw material, should reduce the number of silicic acid bonds. In general, as the degree of condensation of an alkoxysilane increases, the condensate turns into a highly viscous liquid, ultimately into a solid. The alkoxysilane condensate to be suitably used as a starting material should have a degree of condensation of about 2 to 8 in the light of the ease of handling as a raw material as well as the extent of hydrolysis. Attempts to produce a condensate with a high degree of condensation are met with a greater extent of variation in the degree of condensation even when the amount of water added is varied only slightly, so that in this aspect as well, it is preferred to select one with an optimum degree of condensation.

The alkoxysilane condensate is used by itself or as a solution thereof in an aqueous solvent. The term aqueous solvent herein means a solvent soluble in water, specifically a lower alcohol such as methyl alcohol, ethyl alcohol, propyl alcohol, or the like, dioxane, dimethyl sulfoxide, and lower ketones such as acetones and the like, wherein it is preferred to use a lower alcohol such as methyl alcohol, ethyl alcohol, or the like.

The alkoxysilane condensate may be hydrolyzed by adding continuously, a solution of the alkoxysilane condensate itself or a solution thereof in an aqueous solvent into an aqueous solution containing an alkali catalyst or an aqueous solution containing the catalyst and an aqueous solvent. The catalysts that can be used include ammonia, ammonium salts, and the like. The alkoxysilanes include tetramethoxysilane, tetraethoxysilane, tetrapropoxysilane, tetrabutoxysilane, 2-oxyethoxysilane, and the like. The specific reaction conditions call for dissolving, for example, a tetramethoxysilane condensate in methanol and adding it continuously, in 10 to 40 minutes and with stirring, to a mixed solvent of methanol and water containing ammonia, thereby hydrolyzing the tetramethoxysilane. The amount of the catalyst in terms of an ammonia content should be about 0.5 to 3% by weight of the mixed solvent of methanol and water. The reaction should be carried out at a temperature 0 to 40° C. After the reaction is completed, the liquid reaction mixture is then concentrated until reaching an appropriate colloidal silica concentration, followed by replacing the methanol with water, yielding a colloidal silica sol.

Hydrolysis of an alkoxysilane condensate in this manner can produce a cocoon-shaped colloidal silica. Aggregation of two silica particles as initially formed in the reaction generates a cocoon-shaped silica prototype, on which silica generated by hydrolysis grows, ultimately yielding a cocoon-shaped colloidal silica. The resultant colloidal silica exhibits not only excellent properties as abrasive particle for electronic parts but also excellent alkali resistance.

Further, heating the colloidal silica under pressure was able to produce a highly alkali resistant colloidal silica. Heating this under pressure causes the silicic acid bonds of the colloidal silica to react with each other into the formation of a siloxane bond thereby reducing the amount of silicic acid bonds. Specifically, this is a process of heating, in the sol state, the colloidal silica prepared by hydrolysis of an alkoxysilane condensate, in an autoclave at temperatures 105 to 374.1° C.

### DESCRIPTION OF THE PREFERRED EMBODIMENTS

Embodiments of the invention are explained hereinafter

### Example 1

A condensate of tetramethoxysilane with an acid catalyst to an approximately tetramer (hereafter, tetramethoxysilane tetramer) and methanol were mixed at a weight ratio 1:0.62 to generate a raw material solution. Separately, a reactor was charged with a total of 650 g, as a reaction medium, of methanol, water, and ammonia to reach 15% by weight of water and 1% by weight of ammonia therein. The reaction system was cooled to maintain the temperature at 20° C. while the raw material solution was added, and reacted, in 25 minutes at an addition rate of 3.6 ml/min. After the reaction, the liquid reaction mixture was heated and concentrated 3-fold, followed by heating while water was added so that the volume remained unchanged until the liquid temperature reached the boiling point of water, thereby replacing the medium with water and generating a water dispersed sol containing cocoon-shaped colloidal silica particles. The sol silica particles were subjected to a measurement of particle size using a Micro Track Particle Size Analyzer, Model-9340UPA, manufactured by Nikkiso Co. (a device based on a laser Doppler method, which detects the Brownian movement of fine particles), providing an average particle size of 35 nm and showing an extremely narrow particle size distribution. A transmission electron microscope observation of the resultant sol silica particles confirmed a cocoon shape with a minor axis of 20 nm and major axis of 35 nm. The tetramethoxysilane condensate used in Example 1 was confirmed to be an approximately tetramer because it gave 51% by weight of silicon dioxide when said silane was completely hydrolyzed.

This sol was used to prepare a water dispersed polishing composition with 1% by weight of the colloidal silica, 400 ppm by weight of ammonia, and 350 ppm by weight of hydroxyethylcellulose (HEC), and the composition submitted to a silicon wafer polishing test. As a result, the polishing rate was 0.14 μm/min. The polishing devices and conditions were as follows:

| | |
|---|---|
| Polishing machine | ML-461, made by Marutoh Co. |
| Polishing Pad | Surfin by Fujimi Co. |
| No. of Revolutions | 100 rpm |
| Polish pressure | 237 g/cm² |
| Silicon Wafer | 30 mm φ |

The polished wafer was washed with SC-1 and subjected to a surface roughness measurement using a Digital Instruments AFM (NanoScope IIIa Dimension 3100), tapping mode, which showed Ra to be 0.177 nm. A small amount of the water dispersed sol containing cocoon-shaped colloidal silica particles was mixed with a relatively large amount of a separately prepared aqueous alkali solution of a pH of 11.5 and was left standing at ambient temperature for one month, after which the mixed solution remained turbid and the cocoon-shaped colloidal silica particles did not dissolve in the alkali solution.

Example 1 was a case using, as a starting material, a tetramethoxysilane tetramer obtained by condensing tetramethoxysilane to an approximately tetramer with an acid catalyst, which on hydrolysis and condensation yielded a cocoon-shaped colloidal silica. Compared with the cocoon-shaped colloidal silica obtained in Comparative Example 1 to be given later, the colloidal silica of Example 1 had a particle size of 35 nm, smaller than that of Comparative Example 1 with a particle size of 70 nm. The polishing efficiency of (polishing rate) was 0.14 μm/min, better than the Comparative Example 1 with a polishing rate of 0.09 μm/min. In addition, the roughness of the polished surface [for this Example] measured with the AFM was 0.177 nm, far superior to the Ra 0.267 nm of Comparative Example 1. Regarding alkali resistance as well, the colloidal silica of Example 1 did not dissolve when left standing for a long period of time in an aqueous alkali solution of a pH of 11.5, while the colloidal silica of Comparative Example 1 dissolved in an aqueous alkali solution of a pH of 11.5, indicating improved alkali resistance [for this Example].

### Example 2

The sol of Example 1 containing water-dispersed colloidal silica particles was placed, along with a small amount of ammonia, in an autoclave and heated to 200° C. and allowed to stand for 30 minutes. The resultant colloidal silica maintained the cocoon shape of the colloidal silica of Example 1, and it gave a polishing rate by the polishing test, equal to that of Example 1 or better, and a polished surface roughness similar to that of Example 1. A small amount of the resultant sol containing cocoon-shaped colloidal silica particles was mixed with a relatively large amount of a separately prepared aqueous alkali solution of a pH of 11.5 and was left standing at ambient temperature for one month, after which the mixed solution remained turbid and the cocoon-shaped colloidal silica particles did not dissolve in the alkali solution. This shows that the alkali resistance of the colloidal silica improved by heating under pressure [autoclaving].

### Comparative Example 1

A raw material solution was prepared by mixing tetramethoxysilane and methanol at a weight ratio of 1:0.27. Separately, a reactor was charged with a total of 650 g, as a reaction medium, of methanol, water, and ammonia to reach 14.7% by weight of water and 0.93% by weight of ammonia therein. The reaction system was cooled to maintain the temperature at 20° C. while the raw material solution was added, and reacted, in 25 minutes at an addition rate of 3.6 ml/min. Thereafter, in a manner similar to that of Example 1, the mixture was concentrated and replaced with water, yielding a sol containing water-dispersed cocoon-shaped colloidal silica particles. The resultant sol had silica particles with an average particle size of 70 nm as measured by the laser Doppler method. A transmission electron microscope observation of the resultant sol silica particles confirmed a cocoon shape with a minor axis of 40 nm and major axis of 70 nm. Thereafter, in a manner similar to Example 1, the mixture was concentrated and replaced with water, yielding a sol containing water-dispersed cocoon-shaped colloidal silica particles.

The resultant sol was used to prepare a polishing composition as with Example 1 to carry out a silicon wafer polishing test similar to that of Example 1. The polishing rate was 0.09 μm/min. The surface roughness of the polished wafer determined by a method similar to Example 1 showed an Ra of 0.267 nm. A small amount of the resultant sol containing the water dispersed colloidal silica particles was mixed with a relatively large amount of a separately prepared an aqueous alkali solution of a pH of 11.5, which when left standing for 1 month at ambient temperature, resulted in a clear mixed solution, and the colloidal silica particles dissolved in the alkali solution.

Hydrolysis and condensation of an alkoxysilane condensate in the presence of an ammonia or ammonium salt catalyst yields a cocoon-shaped colloidal silica; and the resultant cocoon-shaped colloidal silica exhibits not only excellent performance as abrasive particles for electronic materials and the like, but also excellent alkali resistance. Further heating under pressure of the cocoon-shaped colloidal silica prepared by hydrolyzing and condensing an alkoxysilane condensate in the presence of an ammonia or ammonium salt catalyst yields a cocoon-shaped colloidal silica, and the resultant cocoon-shaped colloidal silica not only gives excellent performance as polishing abrasive particles for electronic materials, but also excellent alkali resistance.

1. A cocoon-shaped colloidal silica that does not dissolve in an aqueous alkali solution of a pH of 11.5 or less.

2. A cocoon-shaped colloidal silica prepared from hydrolyzing an alkoxysilane condensate in the presence of an ammonia or ammonium salt catalyst.

3. A cocoon-shaped colloidal silica prepared by further heating under pressure the colloidal silica prepared by hydrolyzing an alkoxysilane condensate in the presence of an ammonia or ammonium salt catalyst.

4. A cocoon-shaped colloidal silica as set forth in claim 3, wherein the temperature to which said colloidal silica is heated under pressure is 105 to 374.1° C.

5. A cocoon-shaped colloidal silica as set forth in claim 2 or 3 wherein said alkoxysilane condensate has an average degree of condensation of 2 to 8.

6. Polishing abrasive particles comprising the cocoon-shaped colloidal silica as set forth in any one of the claims 1 to 5.

7. A process for manufacture of a cocoon-shaped colloidal silica, the process comprising adding continuously an alkoxysilane condensate or its solution in an aqueous solvent to an aqueous solution of ammonia or an ammonium salt or to an aqueous solution containing ammonia or an ammonium salt and an aqueous solvent, thereby hydrolyzing the alkoxysilane.

8. A process for manufacture of a cocoon-shaped colloidal silica, the process comprising adding continuously an alkoxysilane condensate or its solution in an aqueous solvent to an aqueous solution of ammonia or an ammonium salt or to an aqueous solution containing ammonia or an ammonium salt and an aqueous solvent, thereby hydrolyzing the alkoxysilane; and further heating under pressure.

9. A process for the manufacture of a cocoon-shaped colloidal silica as set forth in claim 8, wherein the temperature to which said alkoxysilane condensate hydrolyzate is heated under pressure is 105 to 374.1° C.

10. A process for the manufacture of a cocoon-shaped colloidal silica as set forth in any one of the claims 7 to claim 9 wherein said alkoxysilane condensate has an average degree of condensation of 2 to 8.
